(19) United States
(12) Patent Application Publication
(10) Pub. No.: US 2008/0166442 A1
(43) Pub. Date: Jul. 10, 2008

(54) Apparatuses For Compression Moulding, Thermal Conditioning, Transporting And Inspecting Objects

(75) Inventors: Alessandro Balboni, Granarolo dell'Emilia (IT); Maurizio Borgatti, Imola (IT); Florenzo Parrinello, Medicina (IT)

Correspondence Address: NIXON & VANDERHYE, PC, 901 NORTH GLEBE ROAD, 11TH FLOOR, ARLINGTON, VA, 22203, US

(73) Assignee: Sacmi Cooperativa Meccanici Imola Societa Cooperativa, Imola (IT)

(21) Appl. No.: 11/885,394

(22) PCT Filed: Sep. 9, 2005
(86) PCT No.: PCT/IB2005/002651

§ 371 Date: Aug. 30, 2007

(30) Foreign Application Priority Data
Mar. 1, 2005 (IT) MO2005A0000048

(51) Int. Cl. B28B 5/00

(52) U.S. Cl. 425/347

(57) ABSTRACT

An apparatus comprises an extruding device arranged for supplying doses of pasty plastics, a moulding carousel provided with a mould device arranged for compression-moulding said doses to obtain objects and a thermal-conditioning carousel to thermally condition said objects; an apparatus comprises carousel arrangement, a conveying unit arrangement supported by said carousel arrangement and movable in relation to said carousel arrangement to move objects and a thermal-conditioning arrangement arranged for thermally conditioning said objects, said thermal-conditioning arrangement being associated with said conveying unit arrangement.

This application is a National Phase of PCT International Application No. PCT/IB2005/002651 filed 9 Sep. 2005 which claims priority to IT Application No. M02005A000048 filed 1 Mar. 2005. The entire contents of these applications are incorporated herein by reference.

The invention relates to apparatuses for moulding and thermal-conditioning of objects, in particular objects made of plastics.

Apparatuses are known for moulding objects made of plastics comprising a carousel rotatable around a rotation axis and provided peripherally with a plurality of moulds arranged so as to be angularly equidistant.

Each mould comprises a die and a punch movable towards and away from each other parallel to the rotation axis of the carousel.

Each die is provided with a cavity into which a dose of pasty plastics is introduced, which is compressed by the respective punch.

Once a dose of plastics has been introduced inside the mould, the latter is closed to mould an object.

The mould is maintained closed for a certain period of time in such a way that the shape of the object stabilises whilst the carousel is rotated.

The moulded objects, after being extracted from the moulds, are transferred to conveyor belts that move the moulded objects through a thermally conditioned environment in which the moulded objects are further cooled.

In order to obtain satisfactory cooling, it is nevertheless necessary to provide interaction duration with the thermally conditioned environment that is rather long and therefore conveyor belts of considerable extent.

An object of the invention is to improve the apparatuses for producing objects through compression-moulding of plastics.

Another object of the invention is to improve the apparatuses for thermal-conditioning of objects.

A further object is to obtain apparatuses for thermal-conditioning of objects having limited overall dimensions.

A still further object is to obtain apparatuses for the thermal-conditioning of objects having high productivity.

In a first aspect of the invention, an apparatus is provided comprising an extruding device arranged for supplying doses of pasty plastics, a moulding carousel provided with a mould device arranged for compression-moulding said doses to obtain objects and a thermal-conditioning device arranged for thermally conditioning said objects, wherein said thermal-conditioning device comprises a thermal-conditioning carousel.

Owing to this aspect of the invention, it is possible to obtain an apparatus having rather limited overall dimensions, inasmuch as the thermal-conditioning carousel has a very compact shape.

Furthermore, the thermal-conditioning carousel has greater stiffness compared with the conveyor belts of the thermal-conditioning devices according to the prior art.

This enables the clearance to be limited compared with the case of flexible conveying elements.

The moulding carousel can consequently be synchronised in a very simple and precise manner with the conditioning carousel, unlike what occurs in the case in which the thermal-conditioning devices are provided with conveyor belts.

In a second aspect of the invention, an apparatus is provided comprising a moving arrangement arranged for moving objects and a thermal-conditioning arrangement arranged for thermally conditioning said objects, wherein said moving arrangement comprises a carousel arrangement and a conveying unit arrangement supported by said carousel and movable in relation to said carousel arrangement, said thermal-conditioning arrangement being associated with said conveying unit.

Owing to this aspect of the invention, it is possible to obtain an apparatus having high productivity in relation to small overall dimensions.

The apparatus in fact enables a plurality of objects to be treated without it being necessary to provide a rotatable carousel having a great diameter.

This enables the space to be limited that is necessary for installing the apparatus.

Owing to this aspect of the invention, it is furthermore possible to maintain an object on a rotatable carousel for a considerable time, for example to obtain satisfactory cooling, without the rotation speed of the carousel having to be diminished, causing a limitation to the productivity of the apparatus.

In a third aspect of the invention, an apparatus is provided for thermally conditioning an object comprising an end and a further end, opposite said end, at which an opening is obtained, comprising a cavity arranged for receiving said object, in such a way that between said cavity and an external surface of said object there is defined a chamber, a supplying element arranged for directing a flow of conditioning fluid to said end, an elongated element arranged for being received in said object through said opening, in such a way that between said elongated element and an internal surface of said object there is defined a further chamber, said elongated element being arranged for directing a further flow of conditioning fluid to said end.

Owing to this aspect of the invention, an object is thermally conditioned, for example cooled, by acting simultaneously from the exterior and from the interior thereof.

In this case, the flow of conditioning fluid and the further flow of conditioning fluid initially interact with the aforementioned end—which may constitute the hottest zone of the object—and subsequently the flow of conditioning fluid and the further flow of conditioning fluid lap the external surface and the internal surface of the object respectively, cooling the external surface and the internal surface effectively.

In a fourth aspect of the invention, an apparatus is provided for thermally conditioning objects, comprising a conditioning chamber arrangement inside which there is defined a guiding arrangement along which said objects are advanced in such a way as to define rows, wherein said guiding arrangement is obtained in a carousel arrangement provided inside said conditioning chamber arrangement.

Owing to this aspect of the invention, it is possible to obtain an apparatus for thermally conditioning objects provided with limited overall dimensions, inasmuch as, unlike what occurs in prior-art apparatuses, it is not necessary to provide long substantially straight channels along which the objects are advanced whilst the objects are thermally conditioned.

Furthermore, as the guiding arrangement may extend between a peripheral zone of the carousel and a central zone of the carousel arrangement, a considerable part of the extent of the carousel arrangement is used to receive the objects, which enables high productivity to be achieved in relation to small overall dimensions.

In a fifth aspect of the invention, an apparatus is provided for thermally conditioning objects, comprising a carousel arrangement arranged for moving objects and a conveying device associated with said carousel arrangement and arranged for conveying a conditioning fluid intended to interact with said objects.

Owing to this aspect of the invention, it is possible to obtain an apparatus for thermally conditioning objects having high efficiency and limited overall dimensions.

The carousel arrangement, in fact, whilst having a much lesser extent than prior-art conveyor belts, can receive a considerable number of objects that are thermally conditioned simultaneously.

In addition, the conveying device direct a flow of fluid to—or suck a flow of fluid from—the objects, causing an intense and fast variation in the temperature thereof.

In a sixth aspect of the invention, an apparatus is provided comprising an extruding device arranged for supplying doses of pasty plastics, a moulding carousel provided with a mould device arranged for compression-moulding said doses to obtain objects and a thermal-conditioning device arranged for cooling said objects, wherein it further comprises an extracting carousel arranged for removing said objects from said thermal-conditioning device, an inspecting device arranged for examining said objects being associated with said extracting carousel.

Owing to this aspect of the invention, it is possible to obtain an apparatus that enables control operations to be conducted on all the objects produced by the apparatus without penalising the productivity of the apparatus.

As the inspecting device is associated with the extracting carousel, it is possible to conduct an examination of the objects whilst the latter are moved from the extracting carousel, without it being necessary to provide for the aforementioned examination a dedicated time that would be added to the cycle time of the apparatus, causing a prolongation thereof.

The invention can be better understood and implemented with reference to the enclosed drawings that show some exemplifying and non-limitative embodiments thereof, in which:

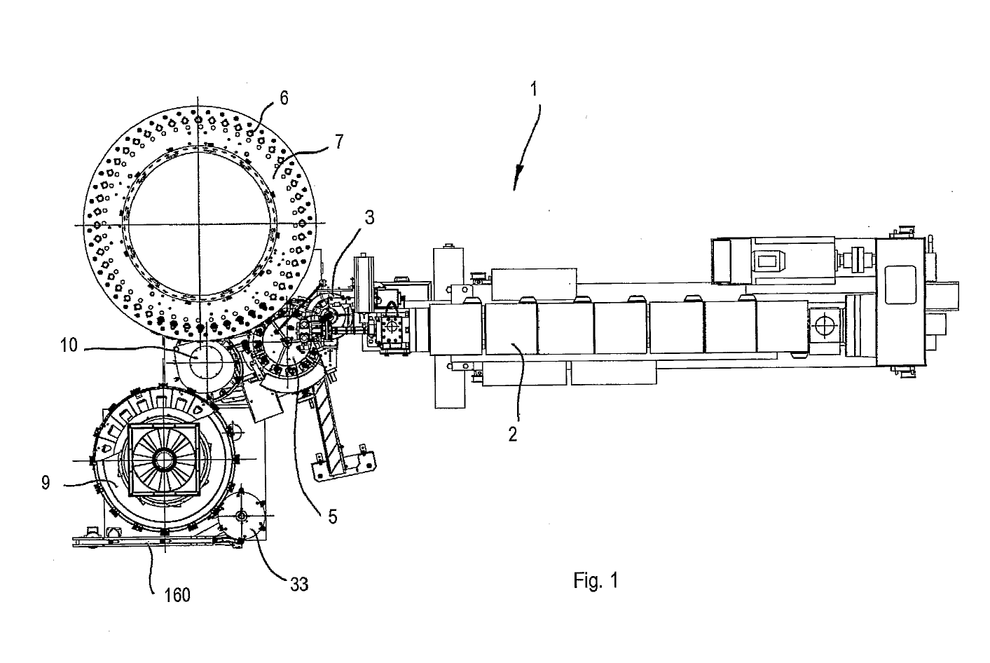

FIG. 1 is a plan view of an apparatus for moulding plastics;

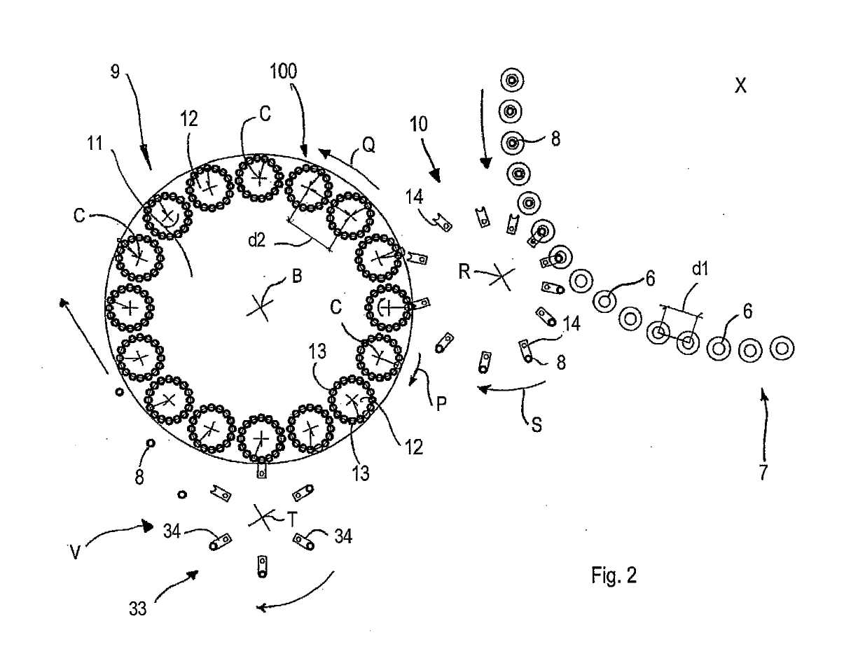

FIG. 2 is a schematic plan view of a moulding carousel, a transferring carousel, a thermal-conditioning carousel and an extracting carousel of the apparatus in FIG. 1;

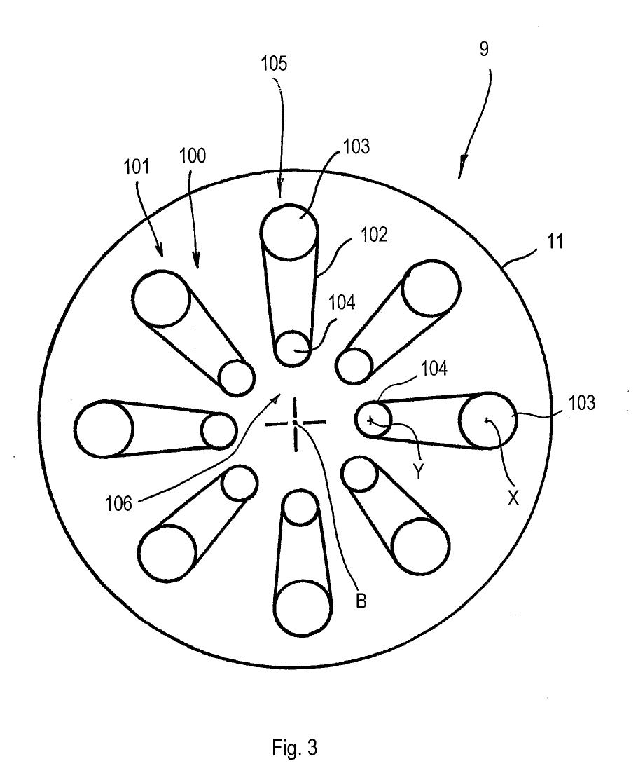

FIG. 3 is a schematic plan view of the thermal-conditioning carousel of the apparatus in FIG. 1, made according to a version;

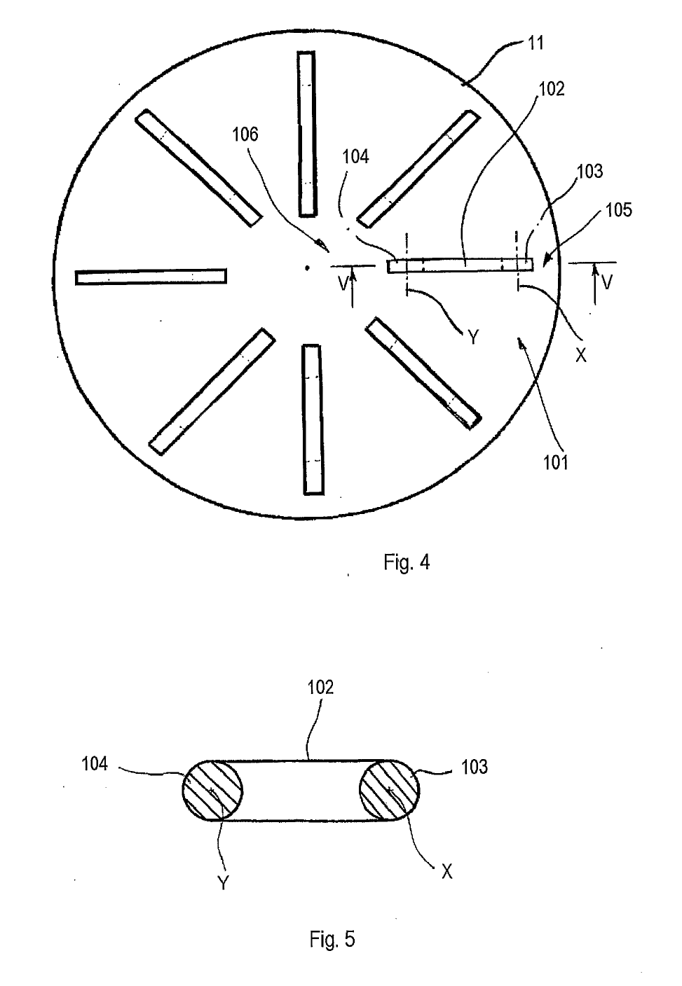

FIG. 4 is a view like the one in FIG. 3, showing another version of the thermal-conditioning carousel;

FIG. 5 is a schematic section taken along a plane V-V in FIG. 4, showing a conveying unit arrangement rotatably supported on the thermal-conditioning carousel;

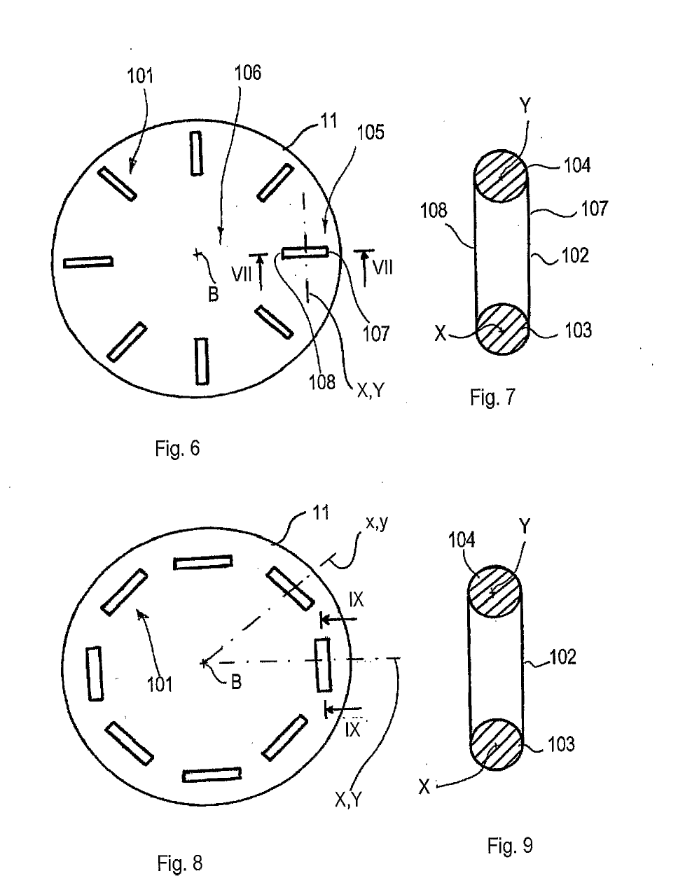

FIG. 6 is a view like the one in FIG. 3, showing a further version of the thermal-conditioning carousel;

FIG. 7 is a schematic section taken along a plane VII-VII in FIG. 6;

FIG. 8 is a view like the one in FIG. 3, showing a still further version of the thermal-conditioning carousel;

FIG. 9 is a schematic section taken along a plane IX-IX in FIG. 8;

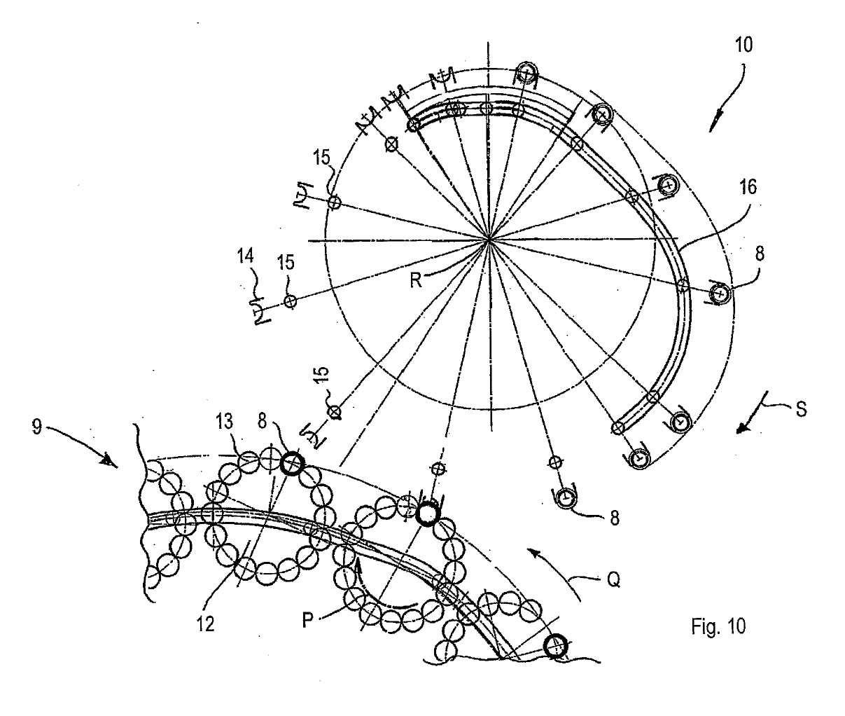

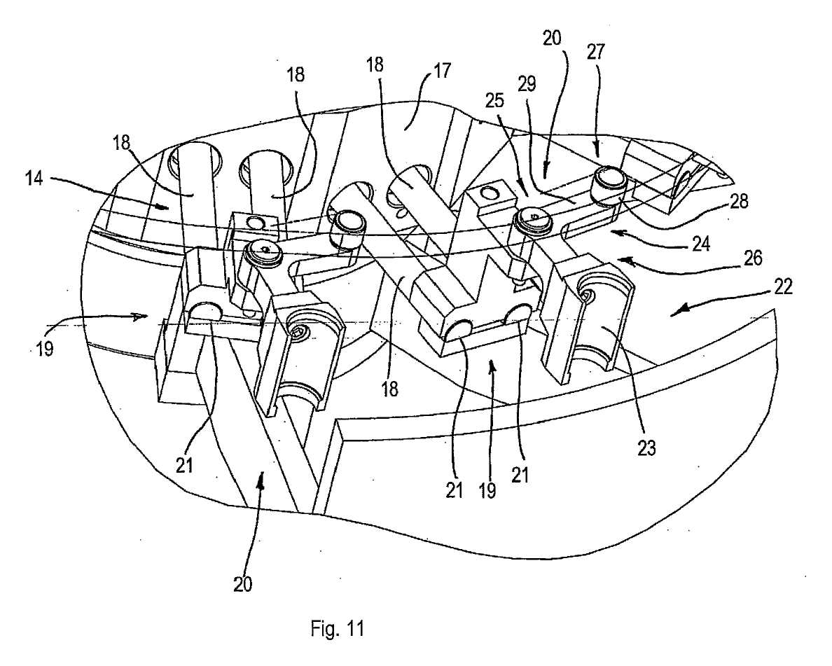

FIG. 10 is a view like the one in FIG. 2, showing in greater detail the transferring carousel;

FIG. 11 is a fragmentary perspective view of a further embodiment of the transferring carousel;

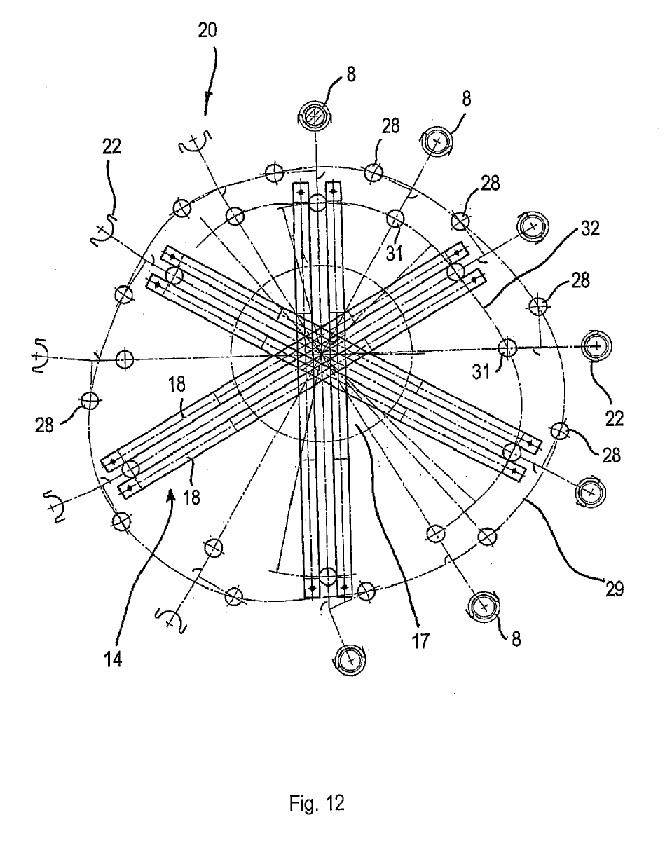

FIG. 12 is a schematic plan view of the transferring carousel in FIG. 11;

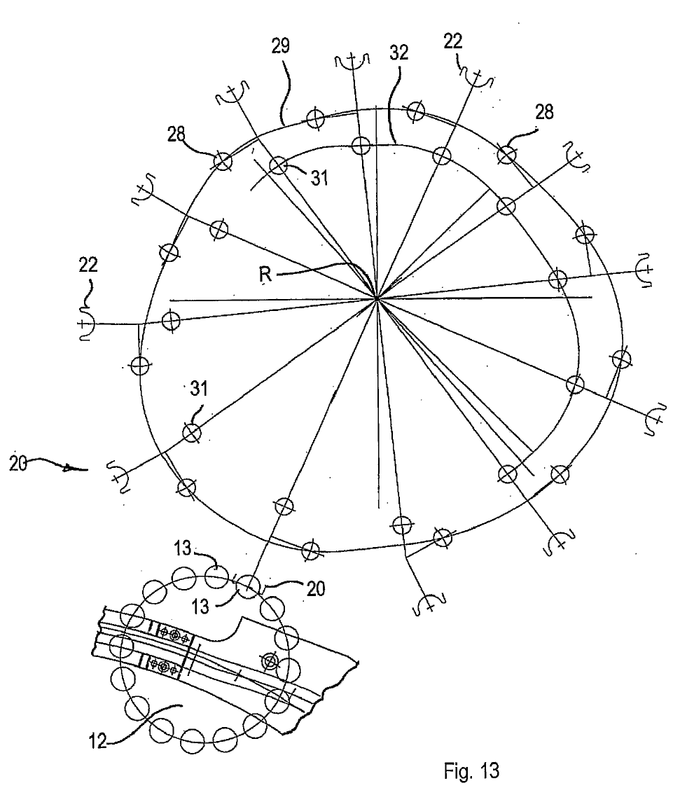

FIG. 13 is a further schematic plan view of the transferring carousel in FIG. 11;

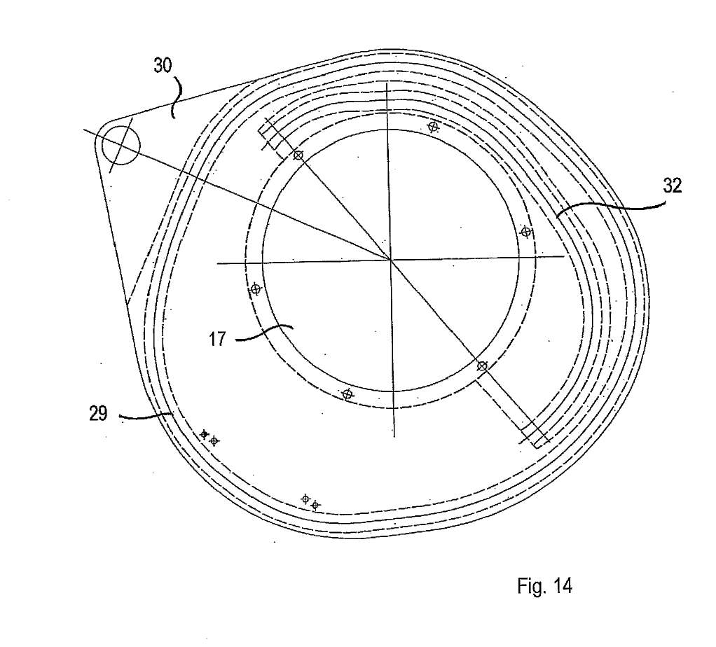

FIG. 14 is a plan view of an upper plate of the transferring carousel of FIG. 11;

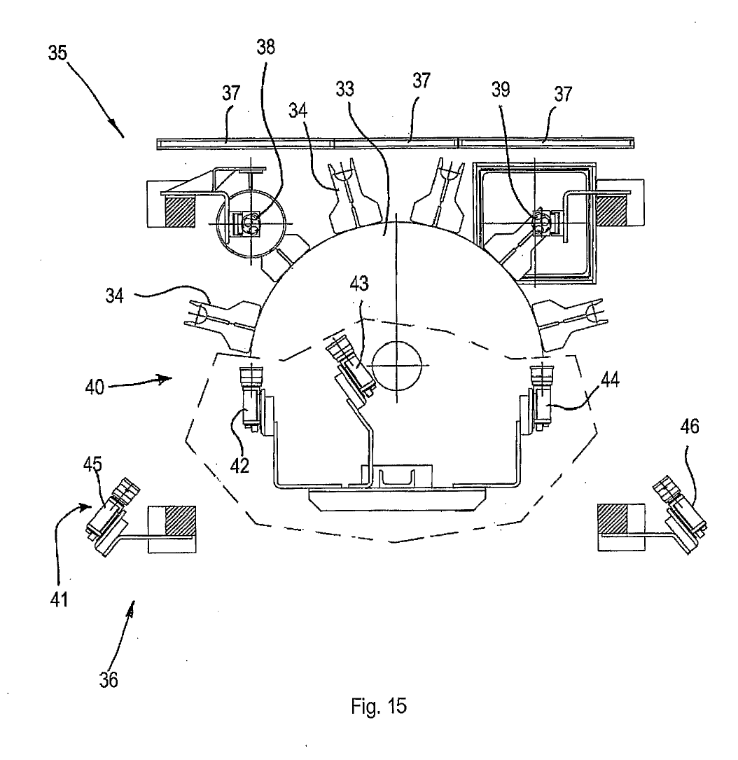

FIG. 15 is a schematic plan view of an extracting carousel;

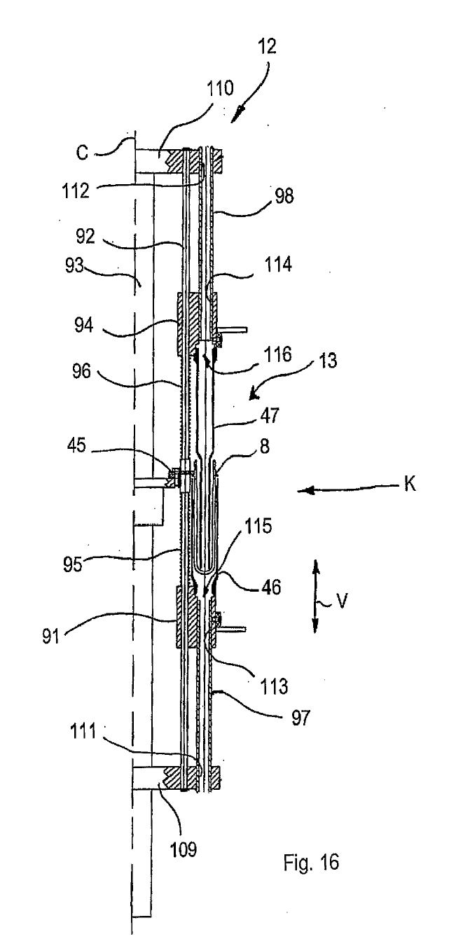

FIG. 16 is a longitudinal section of a thermal-conditioning arrangement associated with the thermal-conditioning carousel, shown in a closed configuration;

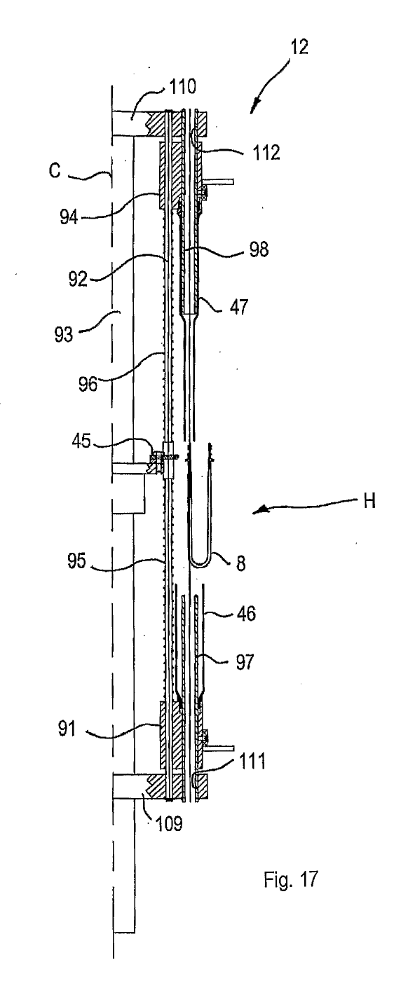

FIG. 17 is a section like the one in FIG. 16 showing the thermal-conditioning arrangement in an open configuration;

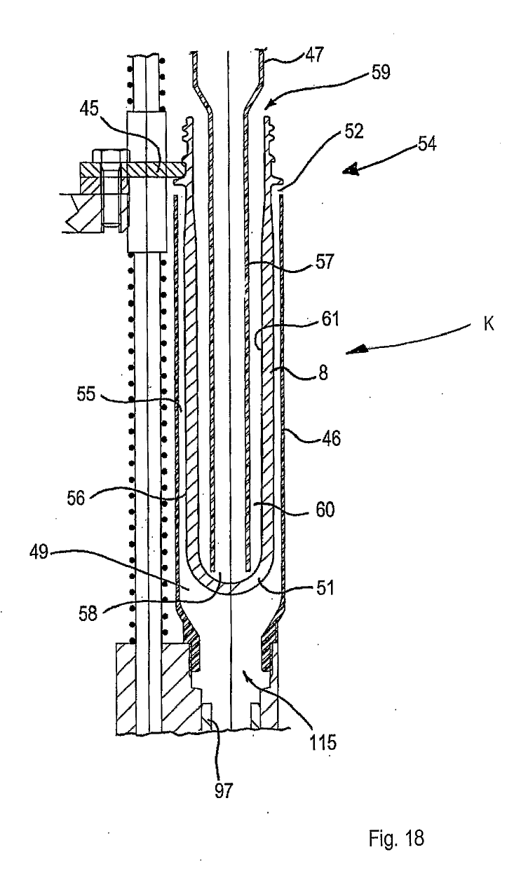

FIG. 18 is a detail of the thermal-conditioning arrangement in FIG. 16;

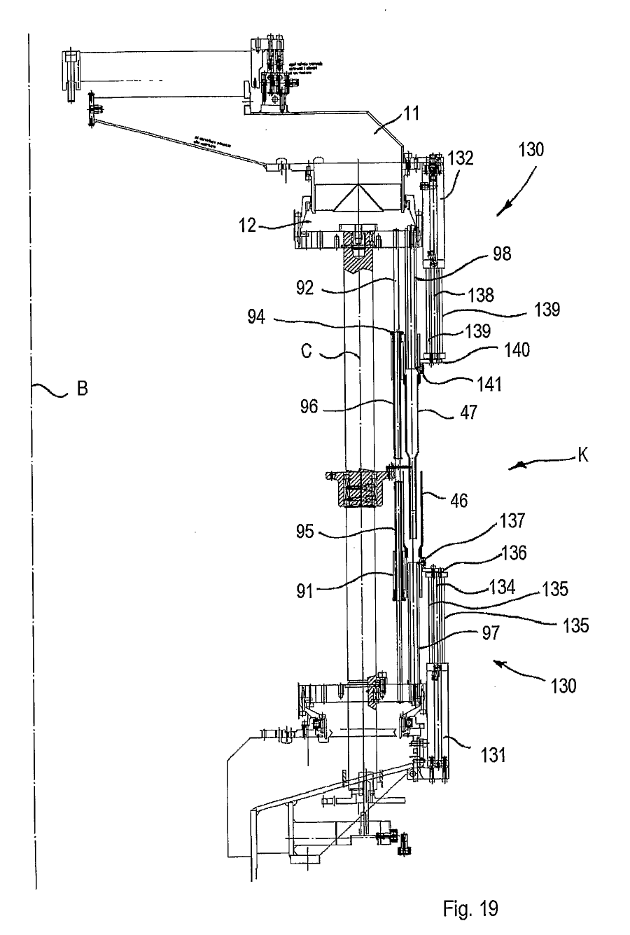

FIG. 19 is a partially sectioned side view of the transferring carousel showing a pneumatic actuating device arranged for moving the thermal-conditioning arrangement;

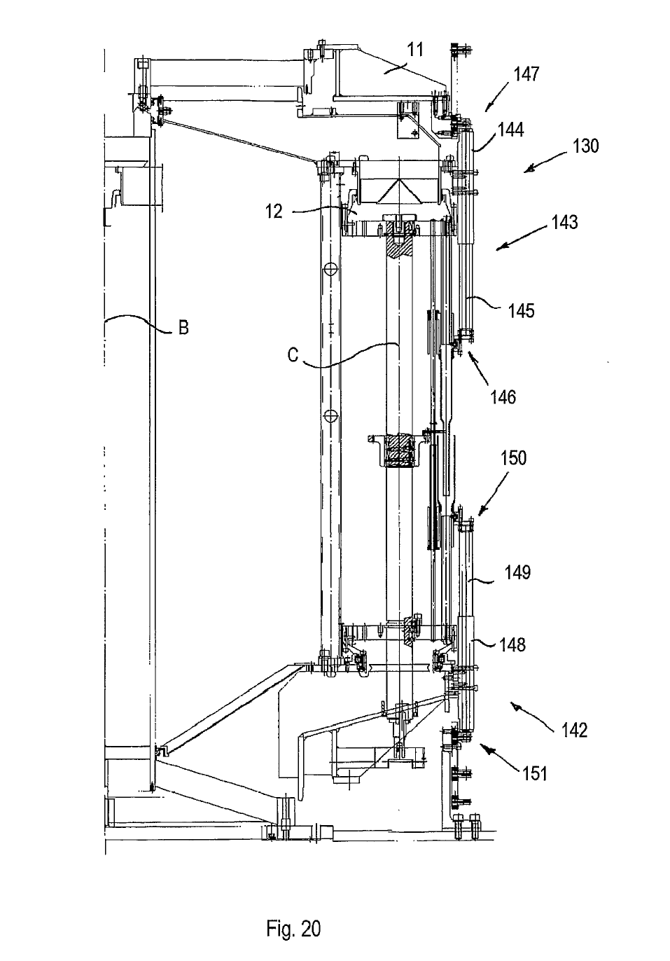

FIG. 20 is a view like the one in FIG. 19 showing a cam actuating device arranged for moving the thermal-conditioning arrangement;

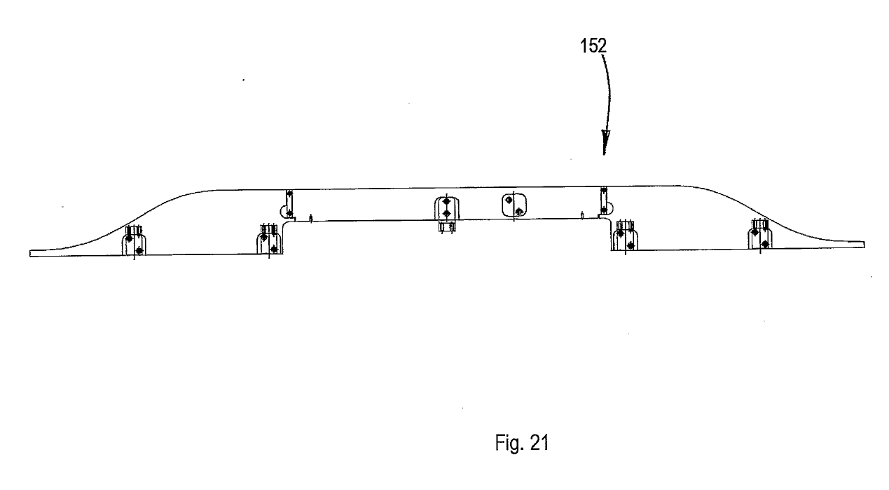

FIG. 21 is a representation on a plane of a cam of the actuating cam device in FIG. 20;

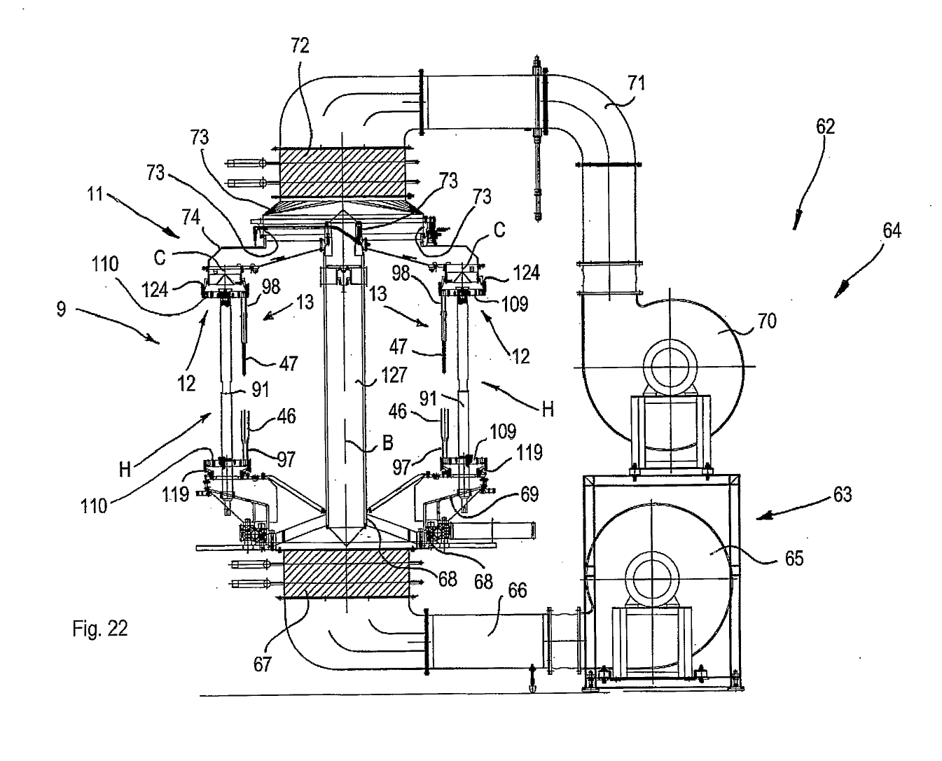

FIG. 22 is a schematic section taken along a longitudinal plane of the thermal-conditioning carousel;

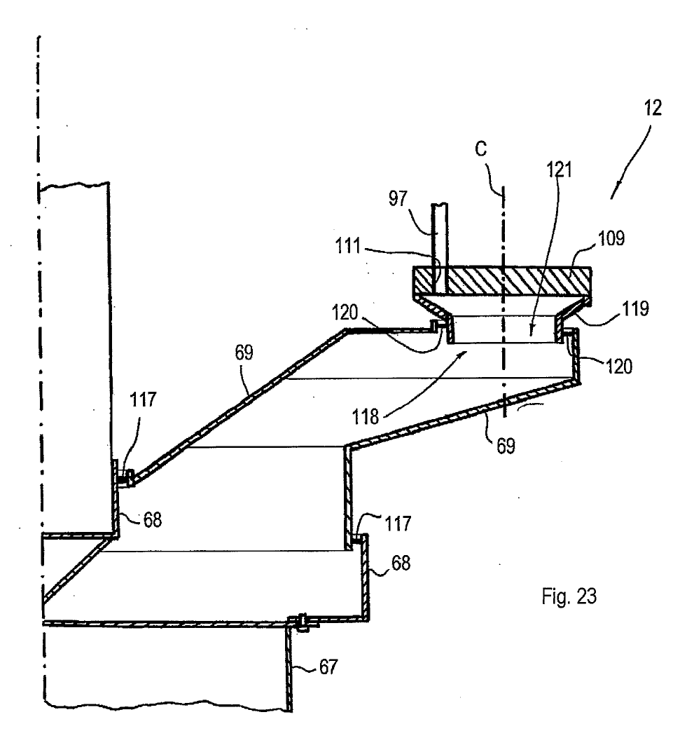

FIG. 23 is a schematic detail in FIG. 22;

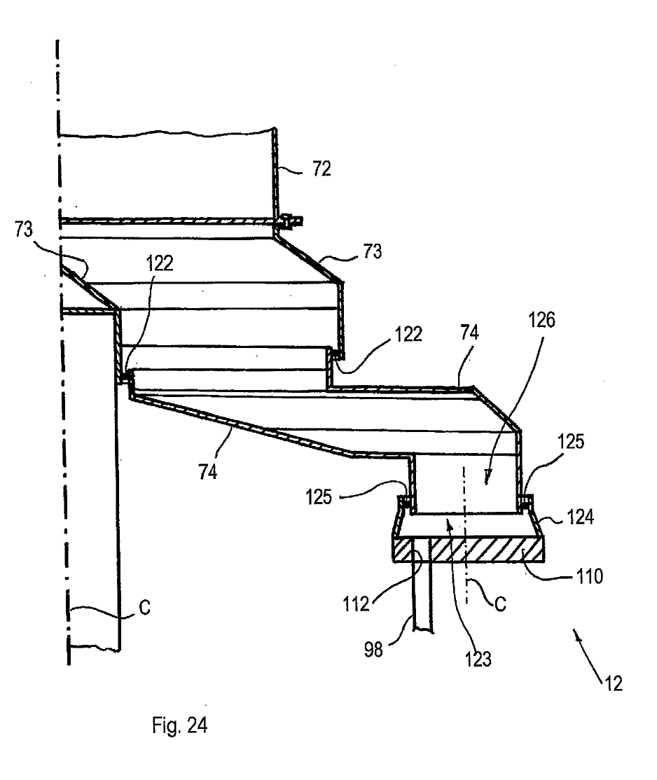

FIG. 24 is a further schematic detail in FIG. 22;

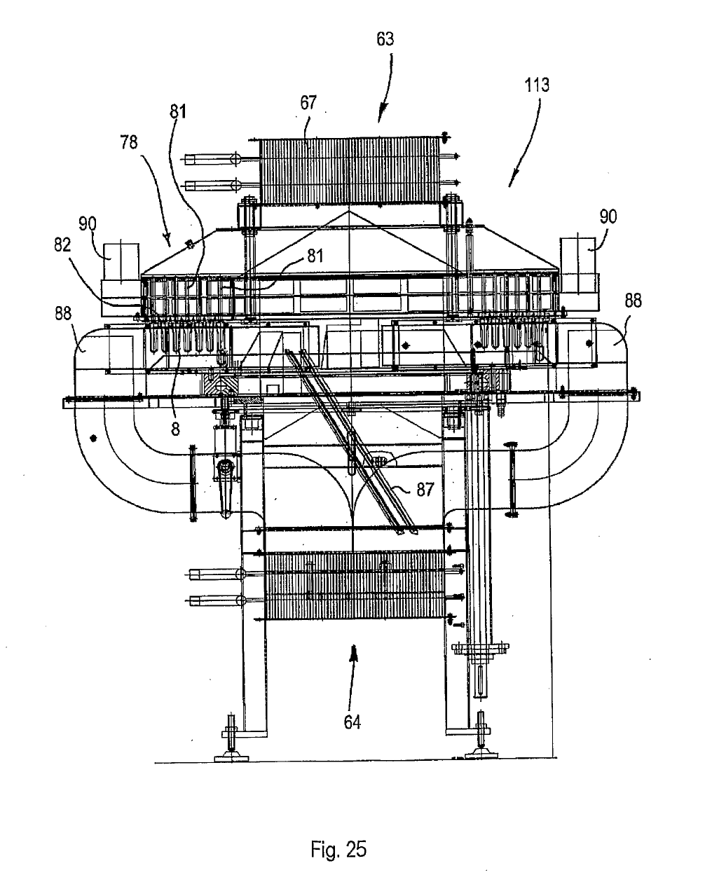

FIG. 25 is a schematic side view of a further version of the thermal-conditioning carousel;

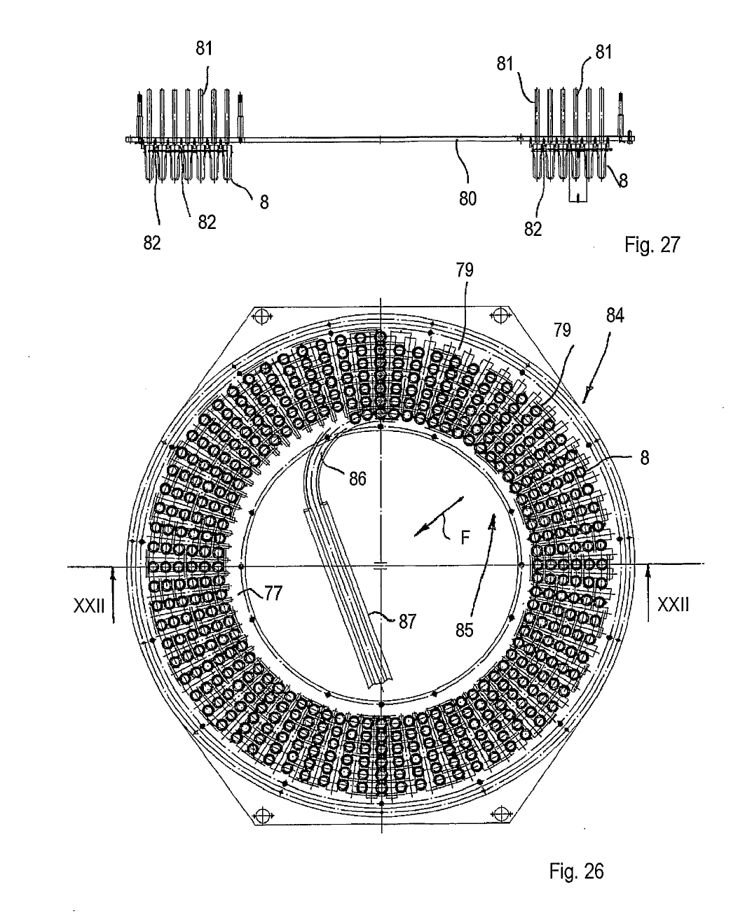

FIG. 26 is a plan view of the thermal-conditioning carousel in FIG. 25;

FIG. 27 is a schematic section taken along a longitudinal plane of the conditioning carousel in FIG. 25;

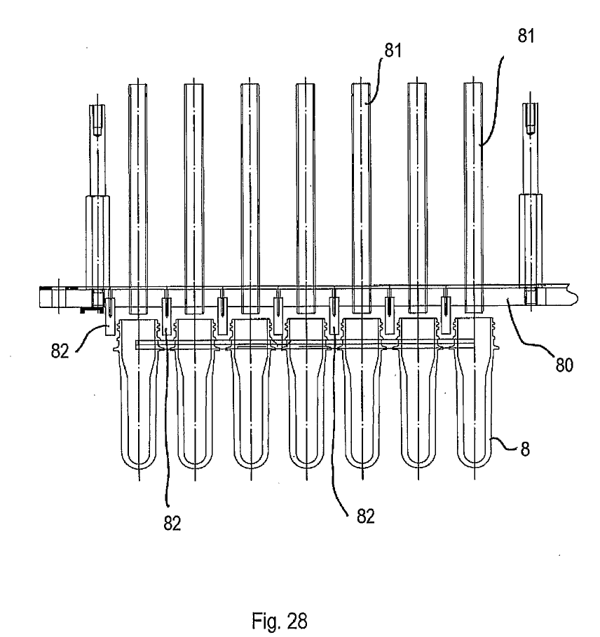

FIG. 28 is a detail of FIG. 27.

With reference to FIG. 1 an apparatus 1 for moulding plastics is shown, comprising an extruder 2 arranged for dispensing pasty plastics and a cutting device 3 that divides the aforementioned plastics into a plurality of doses.

The apparatus 1 furthermore comprises a supplying carousel 5 which transfers the doses to forming moulds 6 with which a moulding carousel 7 is peripherally provided.

The forming moulds 6 mould the doses to obtain objects, for example container preforms 8 (FIGS. 2 and 16).

The apparatus furthermore comprises a thermal-conditioning carousel 9 in which the preforms 8 are thermally conditioned, in particular cooled.

With reference to FIG. 2, the thermal-conditioning carousel 9 comprises a main carousel 11, that is rotatable in a rotating direction Q around a rotation axis B, provided with a plurality of conveying units 100 movable in relation to the main carousel 11.

The conveying units 100 may comprise a plurality of further carousels 12, each further carousel 12 being rotatable in a further rotating direction P around a further rotation axis C arranged substantially parallel to the rotation axis B.

In an embodiment that is not shown, the further carousels 12 can be positioned substantially radially to the main carousel 11.

In this case, the further rotation axes C are arranged substantially parallel to the main carousel 11, the further carousels 12 being arranged along diametral planes of the main carousel 11.

In this way, by providing further carousels 12 provided with a longitudinal dimension that is much less than a transverse dimensions—i.e. the further carousels 12 having a thickness lesser than the diameter—it is possible to install a very considerable number of further carousels 12 on the main carousel 11 enabling the main carousel 11, for the same dimensions, to receive a considerably greater number of preforms 8 compared with the case of further carousels having the further rotation axis C substantially parallel to the rotation axis B.

In another embodiment that is not shown, the further carousels 12 may be arranged in such a way that the respective further rotation axes C are positioned substantially radially in relation to the main carousel 11.

As shown in FIGS. 3 to 9, the conveying units 100 may comprise, instead of the further carousels 12, loop conveying units 101 each of which is provided with a loop flexible element 102, for example a belt, or a chain, made taut between a first rolling element 103 and a second rolling element 104, one of which is motorized.

Alternatively, more than two rolling elements can be provided.

The first rolling element 103 is rotatable around a first rotation axis X, whereas the second rolling element 104 is rotatable around a second rotation axis Y.

With reference to FIG. 3, the loop flexible element 102 is positioned in such a way that the first rotation axis X and the second rotation axis Y are arranged substantially parallel to the rotation axis B.

The first rolling element 103 is arranged near to a peripheral zone 105 of the main carousel 11, whereas the second rolling element 104 is arranged near to a central zone 106 of the main carousel 11, the first rotation axis X and the second rotation axis Y being positioned in such a way as to define a diametral plane of the main carousel 11. With reference to FIGS. 4 and 5, the loop flexible element 102 is positioned in such a way as to define a diametral plane of the main carousel 11.

The first rolling element 103 is arranged near to a peripheral zone 105 of the main carousel 11, whereas the second rolling element 104 is arranged near to a central zone 106 of the main carousel 11, the first rotation axis X and the second rotation axis Y being positioned in such a way as to define a plane that is substantially parallel to the main carousel 11.

In the embodiments shown in FIG. 3 and FIGS. 4 and 5, as the loop flexible element 102 extends between the peripheral zone 105, at which the loop flexible element 102 receives the preforms 8, and the central zone 106, very high productivity of the thermal-conditioning carousel 9 is obtained inasmuch as it is possible also to position preforms 8 at an internal portion of the main carousel 11.

In this way, the thermal-conditioning carousel 9, although having limited dimensions, can receive a great number of performs 8.

With reference to FIGS. 6 and 7, an embodiment of the thermal-conditioning carousel 9 is shown, in which both the first rolling element 103 and the second rolling element 104 of each loop conveying unit 101 are positioned near to the peripheral zone 106, the second rolling element 104 being aligned on and overlapping the first rolling element 103.

The loop flexible element 102 is positioned in such a way as to have a first branch 107 facing the peripheral zone 105 and a second branch 108 facing the central zone 106.

With reference to FIGS. 8 and 9, an embodiment of the thermal-conditioning carousel 9 is shown, in which both the first rolling element 103 and the second rolling element 104 of each loop conveying unit 101 are positioned near to the peripheral zone 106, the second rolling element 104 being aligned on and overlapping first rolling element 103.

The first rotation axis X and the second rotation axis Y are arranged substantially radially in relation to the main carousel 11, so as to define a diametral plane of the main carousel 11.

The embodiments shown in FIGS. 6 and 7 and in FIGS. 8 and 9 enable thermal-conditioning carousel 9 to be made that significantly extend in a direction that is substantially parallel to the rotation axis B.

These thermal-conditioning carousels may process a plurality of preforms, whilst maintaining a very reduced plan dimension.

These thermal-conditioning carousels are consequently particularly suitable for being installed inside environments that, since not having a significant surface extent, require a very careful exploitation of the internal space.

The thermal-conditioning carousel 9 can be angularly indexed, or continuously.

Similarly, also each of the further carousels 12 can be angularly indexed, or continuously.

Each further carousel 12 is furthermore provided peripherally with a plurality of cooling devices 13, for example devices that are angularly equidistant from one another.

It should be noted that, for the same number of cooling devices 13, the dimensions of the thermal-conditioning carousel 9 are significantly less compared to the dimensions that the thermal-conditioning carousel 9 would have if the thermal-conditioning devices 13 were rotatably supported directly on a peripheral region of the main carousel 11.

Similarly to what has been disclosed above with reference to the further carousels 12, each of the loop flexible elements 101 can be indexed, or continuously.

Furthermore, each loop flexible element 101 can be peripherally provided with a plurality of cooling devices 13, for example arranged in such a way as to be equidistant from one another.

As shown in FIG. 10, the apparatus 1 is furthermore provided with a transferring carousel 10 that removes the preforms 8 from the moulding carousel 7 to deposit the preforms 8 in the thermal-conditioning carousel 9.

The transferring carousel 10 is rotatable around a still further rotation axis R, in a still further rotating direction S, opposite the rotating direction Q.

The transferring carousel 10 is provided with a plurality of arm elements 14, arranged for removing and releasing the preforms, which rotate coupled to the transferring carousel 10 and can move radially in relation to the still further rotation axis R.

Each arm element 14 comprises a guiding element 15 shaped so as to slide inside a groove 16, shaped like a cam profile, that extends around the further axis R in such a way as to be nearer to the still further rotation axis R near to the moulding carousel 7 and farther from the still further rotation axis R near to the thermal-conditioning carousel 9. This enables the arm elements 14 to be provided with a tangential speed that varies according to position, this tangential speed being greater near to the thermal-conditioning carousel 9.

Each arm element 14 may be provided, at an end thereof that is farther from the still further rotation axis R, with a handling unit rotatably supported on the arm element 14, this handling unit removing the preforms 8 from the moulding carousel 7 to deliver the performs 8 to the thermal-conditioning carousel 9.

A control device can be furthermore provided to control rotation of each handling unit in relation to the corresponding arm element 14.

During a complete revolution of the main carousel 11, a preform 8 is deposited in a cooling device 13 of each of the further carousels 12.

Preforms 8 supported by arm elements 14 that are adjacent to one another are positioned inside cooling devices 13 associated with further carousels 12 adjacent to one another.

Subsequently, each further carousel 12 is rotated in such a way that a cooling device 13 inside which there is no preform, is facing the transferring carousel 10.

During a subsequent revolution of the main carousel 11, a further preform 8 is deposited in a further cooling device 13 of each of the further carousels 12.

Each of the aforementioned further preforms is received in a cooling device 13 that is adjacent to the cooling device 13 that has received one of the aforementioned preforms 8 during the preceding revolution of the main carousel 11.

This operation is repeated until all the cooling devices 13 have been supplied with preforms 8.

A this point, a preform is removed from a cooling device 13 of a further carousel 12, to enable a still further preform 8 to be inserted into the aforementioned cooling device 13.

In particular, if the further carousels 12 angularly index, each further carousel 12 performs a rotation equal to an angular step at each revolution of the main carousel 11.

Advantageously, each further carousel 12 performs at least part of the aforementioned rotation when the further carousel 12 is near to the transferring carousel 10.

In this way, as the further rotating direction P of the further carousels 12 is opposite the rotating direction Q of the main carousel, it is possible to obtain a time increase during which each arm element 14 can interact with a respective cooling device 13, so that a preform 8 can be more easily delivered to the thermal-conditioning carousel 9.

It is observed that the preform 8 is maintained inside the respective cooling device 13 for a number of revolutions of the main carousel 11 equal to the number of the cooling devices 13 provided on each of the further carousels 12.

With reference to FIGS. 11 to 14, an embodiment of the transferring carousel 10 is shown, comprising a turntable 17 on which the arm elements 14 are slidingly supported.

The arm elements 14 are arranged radially in relation to the turntable 17, central portions of the arm elements overlapping one another.

Each arm element 14 comprises a pair of rods 18 slidable inside suitable seats obtained in the turntable 17.

At opposite ends of each pair of rods 18 are provided supporting blocks 19 arranged for mutually connecting the rods 18 and for supporting a handling unit 20 arranged for moving the preforms 8.

The rods 18 are substantially cylinder-shaped and comprise at least a sliding coupling portion that is slidable in one of the seats of the turntable 217.

The rods 18 have, at the central portion and at the end zones, a milled part 21 that enables the space requirements of the transferring carousel 10 to be limited parallel to the still further rotation axis R, when the arm elements are arranged on top of one another.

In other words, the central portion and the end zones have a transverse dimension that is less than the aforementioned coupling portion.

Each arm element 14 is provided with two handling units 20 associated with opposite ends of the rods 18. In this way, each arm element 14 can move two preforms 8, in the manner that will be disclosed below.

Each handling unit 20 comprises a removing element 22 provided with an alveolus 23 arranged for receiving a preform 8.

The removing element 22 is connected to a lever 24 rotatably supported on a respective supporting block 19.

The lever 24, being for example L-shaped, comprises a central portion 25 hinged on the supporting block 19, a first end 26 with which the removing element 22 is associated and a second end 27 on which a rolling element 28 is rotatably supported that is arranged for engaging a cam profile 29 obtained in a fixed plate 30 of the transferring carousel 10 arranged above the turntable 17.

The rolling element 28, cooperating with the cam profile 29, controls oscillation of the removing element 22 in relation to the corresponding supporting block 19.

On each arm element 14 a further rolling element 31 is furthermore rotatably supported that is arranged for engaging a further cam profile 32 obtained in the fixed plate 30.

The further rolling element 31, by cooperating with the further cam profile 32, controls sliding of the removing element 22 in relation to the turntable 17.

In operation, whilst the turntable 17 is rotated, each removing element 22 removes a preform from the moulding carousel 7 and delivers the preform to the thermal-conditioning carousel 9.

As shown in FIG. 2, adjacent forming moulds on the moulding carousel 7 are separated by a distance d1 that is less than a further distance d2 that separates a first cooling device 13, associated with a first further carousel 12, and a second cooling device 13, associated with a second further carousel 12 adjacent to the first further carousel 12.

The further rolling element 31, engaging the further cam profile 32, obliges the rods 18 to slide in relation to the rotating plate 17. In this way, it is possible to remove the preforms 8 from the moulding carousel 7 according to a preset removing pitch and transfer the preforms 8 to the further carousels 12 of the thermal-conditioning carousel 9 according to a preset delivery pitch that is different from the removing pitch.

The rolling element 28, engaging the cam profile 29, obliges the removing elements 22 to oscillate in relation to the respective supporting blocks 19, this enables the delivering operations of the preforms 8 to the thermal-conditioning carousel 9 to be simplified.

The further cam profile 29, is in fact shaped in such a way that each removing element 22, controlled by the respective rolling element 28, travels along a trajectory a portion of which substantially coincides with a further trajectory along which the cooling devices 13 travel that are installed on the further carousels 12.

Similarly, a further portion of the trajectory along which the removing element 22 travels substantially coincides with a still further trajectory along which the forming moulds 6 travel that are installed on the moulding carousel 7.

The rolling element 28 and the cam profile 29 enable greater time to be obtained during which a preform 8 can be delivered to the thermal-conditioning carousel 9 compared with the cases in which the removing elements 22 are shaped in such a way as to interact with the cooling devices 13 only when the respective trajectories are tangent.

For the same reasons, it is possible to increase a period of time in which a preform is removed from the moulding carousel 7.

As shown in FIGS. 1, 2 and 15, the apparatus furthermore comprises a removing carousel 33 provided with a plurality of removing arms 34 that remove the preforms 28 from the carousel 5 and deliver the preforms to a conveying device 160.

An inspecting device 35 arranged for examining the preforms 8, in order to detect any defects whilst the preforms are moved from the removing carousel 34, are associated with the removing carousel 34.

The inspecting device comprises a lighting device 37 and television-camera arrangement 36 cooperating with the lighting device 37.

During rotation of the removing carousel 33, each preform 8, supported by a respective removing arm 34, is interposed between the lighting device 37 and the television-camera arrangement 36 in such a way that the latter can detect images of the preform 8 that are examined by electronic processing units with which the inspecting device 35 is provided.

The television-camera arrangement 36 comprises a first television-camera 38, positioned above the removing carousel 33, and arranged for detecting any defects that may be current in neck zones of the preforms.

The television-camera arrangement 36 furthermore comprises a second television-camera 39, which is also positioned above the removing carousel 33, and is arranged for detecting any defects that may be current in bottom zones of the preforms. In addition, the television-camera arrangement 36 is provided with a group of television-cameras 40 and with a further group of television-cameras 41 arranged for examining an intermediate portion of the preforms 8.

The group of television-cameras 40 comprises a third television-camera 42, a fourth television-camera 43 and a fifth television-camera 44 arranged in such a way as to frame different portions of a side surface of the preforms 8 to detect defects such as stains, dirt, bubbles, inclusions, crystallisation, undesired colouration.

The group of television-cameras 40 identifies preforms having defects that cause variation in light absorption in relation to cases of qualitatively suitable preforms.

Alternatively, devices can be provided that operate by detecting the reflection or refraction of light.

The further group of television-cameras 41 comprises a sixth television-camera 45 and a seventh television-camera 46 that are arranged in such a way as to frame different portions of a side surface of the preforms 8 to detect shrinkage of materials or deformation of the surface of the preforms that do not give rise to abnormal absorption of light.

As the inspecting device 35 is associated directly with the removing carousel 33, it is possible to check all the preforms 8 produced without penalising the efficiency of the apparatus 1.

In known apparatuses, on the other hand, the preforms, after forming, are accumulated in storage containers and have to be removed from the aforementioned containers, delivered to conveying devices and positioned in a preset configuration before being able to be examined by inspecting devices.

The inspecting operations consequently require very significant execution periods and cannot be carried out during a productive cycle in order not to penalise the productive cycle in an unacceptable manner.

By contrast, in the apparatus according to the invention, the inspecting operations can be carried out without any extension to cycle time.

With reference to FIGS. 16 and 17 a further carousel 12 supporting a cooling device 13 is shown.

FIGS. 16 and 17 show, for ease of reference, only one cooling device 13 of the plurality of cooling devices 13 actually installed on the further carousel 12.

The cooling devices 13 comprise a supporting element 45, shaped so as to support the preform 8.

The cooling devices 13 furthermore comprise a tubular element 46, the preform 8 being received inside the tubular element 46.

Inside the tubular element 46, the preform 8 is cooled through a flow of fluid.

Alternatively, the preform can be placed in contact with the tubular element 46 and be cooled by recirculating fluid through conduits obtained in the tubular element 46.

The cooling devices 13 furthermore comprise an elongated element 47 arranged for directing a further flow of fluid into the preform.

Alternatively, cooling can occur through sucking of fluid, or by contact with the surface of the elongated element 47, the latter being internally cooled by a liquid that circulates in conduits obtained therein.

The tubular element 46 and the elongated element 47 are movable towards, and away from, each other in a direction V, in such a way as to enable a preform 8 to be positioned in the cooling device 13 and to be removing from the latter, once the preform 8 has been cooled.

In particular, the cooling devices 13 can assume an open configuration H, shown in FIG. 17, in which the tubular element 46 and the elongated element 47 are spaced at a distance from each other to enable a preform 8 to be removed from, or delivered to, the cooling device 13, and a closed configuration, indicated by K in FIGS. 16 and 18, in which the elongated element 47 is partially received inside the tubular element 46.

The tubular element 46 is supported by a slide 91 that is slidable on a guide column 92 arranged substantially parallel to a shaft 93 arranged for rotating the carousel 12.

Similarly, the elongated element 47 is supported by a further slide 94 slidable on the guide column 92.

The slide 91 and the further slide 94 can be slid along the guide column 92 by any known device, for example a hydraulic actuating device, a pneumatic actuating device, a cam actuating device, an electromechanical actuating device.

A spring 95 acting on the slide 91 and a further spring 96 acting on the further slide 94 that tend to remove from each other the elongated element 47 and the tubular element 46, in such a way as to take the cooling devices 13 to the open configuration H, are associated with the guide column 92.

The cooling devices 13 furthermore comprise a pipe 97 arranged for conveying the flow of fluid to the tubular element 46 and a further pipe 98 arranged for conveying the further flow of fluid to the elongated element 47.

The pipe 97 and the further pipe 98 are fixed respectively to a plate 109 and to a further plate 110 connected to opposite end zones of the shaft 93.

The plate 109 is provided with a hole 111 through which the pipe 97 passes, the pipe 97 being supplied with the flow of fluid by the devices and in the manner that will be illustrated below.

Similarly, the further plate 110 is provided with further hole 112 through which the further pipe 98 passes, the further pipe 98 being supplied with the further flow of fluid by the devices and in the manner that will be illustrated below.

Inside the slide 91 a seat 113 is obtained that is arranged for receiving the pipe 97, in such a way as to enable the slide 91 to slide on the pipe 97.

The seat 113 is shaped in such a way as to connect the pipe 97 with the tubular element 46 in the closed configuration K.

In the further slide 94 a further seat 114 is obtained that is arranged for receiving the further pipe 98, in such a way as to enable the further slide 94 to slide on the further pipe 97.

The further seat 114 is shaped in such a way as to connect the further pipe 98 with the elongated element 47 in the closed configuration K.

In a portion of the tubular element 46 nearer the slide 91, an opening 115 is obtained that enables the pipe 97 to be partially received inside the elongated element 46, when the cooling devices 13 change from the closed configuration K to the open configuration H.

Similarly, in a portion of the elongated element 47 nearer the further slide 94 a further opening 116 is obtained that enables the further pipe 98 to be partially received inside the tubular element 47, when the cooling devices 13 change from the closed configuration K to the open configuration H. As shown in FIG. 18, the pipe 97 leads into a chamber 49 obtained in the tubular element 46 and arranged for receiving the preforms 8 at the opening 115 that face towards a bottom zone 51 of the preforms 8.

Between the preforms 8 and the chamber 49, at a neck zone 54 of the preforms 8, a passage 52 is defined that connects the chamber 49 with the external environment.

In operation, the flow of fluid, for example pressurised air, is introduced inside the chamber 49 through the opening 115.

The flow of fluid initially interacts with the bottom zone 51 of the preforms 8 and subsequently, by advancing through a gap 55 defined between an external surface 56 of the preforms 8 and the chamber 49, the flow reaches the passage 52 through which the flow is expelled into the external environment.

The elongated element 47 comprises a dispenser 57 provided at an end thereof with an orifice 58 facing the bottom zone 51 of the preforms 8.

The dispenser 57 is introduced inside the preforms 8 through an opening zone 59 of the latter and is positioned in such a way that the orifice 58 is placed at a certain distance from the bottom zone 51.

Between the further supplying conduit 57 and an internal surface 61 of the preforms 8 a further gap 60 is defined that is connected with the external environment at the opening zone 59.

In operation, the further flow of fluid, for example pressurised air, is directed to the bottom zone 51, laps the internal surface 61 and reaches the external environment through the opening zone 59.

The above disclosure shows that each preform 8 is cooled by a flow of pressurised fluid and by a further flow of pressurised fluid that simultaneously interact with the external surface 56 and with the internal surface 61, respectively.

Each preform 8 is thus subjected to effective cooling that enables good dimensional stability to be obtained and forming of undesired crystallisation of the plastics to be avoided with which the preform 8 is made.

With reference to FIG. 19 a driving device 130 arranged for moving the tubular elements 46 and the elongated elements 47 is shown.

The driving device 130 comprises a plurality of first pneumatic cylinders 131 arranged for moving the tubular elements 46 and a plurality of second pneumatic cylinders 132 arranged for moving the elongated elements 47.

A number of first pneumatic cylinders 131 is provided corresponding to the number of further carousels 12 rotatably supported by the main carousel 11, a corresponding first pneumatic cylinder 131 being associated with each further carousel 11.

Similarly, a number of second pneumatic cylinders 132 is provided corresponding to the number of further carousels 12 rotatably supported by the main carousel 11, a corresponding second pneumatic cylinder 131 being associated with each further carousel 11.

The first pneumatic cylinders 131 and the second pneumatic cylinders 132 are fixed to the main carousel 11 and rotate together with the main carousel 11 around the rotation axis B.

Each first cylinder 131 comprises a stem 134 that is movable between a retracted position and an extended position and guided between the aforementioned retracted position and the aforementioned extended position by bars 135.

A bracket 136 that is arranged for moving the slide 91 along the guide column 92 is associated with a free end of the stem 134.

The bracket 136 interacts with a rolling element 137 rotatably supported by the slide 91.

Similarly, each second cylinder 132 comprises a further stem 138 that is movable between a further retracted position and a further extended position, and guided between the aforementioned retracted position and the aforementioned extended position by further bars 139.

A further bracket 140 arranged for moving the further slide 94 along the guide column 92 is associated with a free end of the further stem 138.

The further bracket 140 interacts with a further rolling element 141 that is rotatably supported by the further slide 94.

When the tubular element 46 and the elongated element have been moved near each other and the further carousel 12 has been rotated around the respective further rotation axis C, the rotating element 137 is delivered to a guide and the further rotating element 141 is delivered to a further guide.

The aforementioned guide and the aforementioned further guide partially surround the further carousel 12 and maintain the cooling device 13 in the closed configuration K.

The first pneumatic cylinder 131 and the second pneumatic cylinder 132 furthermore return the cooling device 13 to the open configuration H by cooperating with the spring 95 and with the further spring 96.

This occurs after the aforementioned guide has delivered the rolling element to the bracket 136, whilst the stem 134 is in the extended position, and the further guide has delivered the further rolling element 141 to the further bracket 140, whilst the further stem 138 is in the further extended position.

In this way, it is possible to use only one first pneumatic cylinder and only one second pneumatic cylinder for each further carousel, this first pneumatic cylinder interacting in succession with all the cooling devices 13 provided on the further carousel 12.

Alternatively, it is possible to provide a number of pneumatic cylinders that is equal to the number of cooling devices. In this case, the pneumatic cylinders can be installed on the further carousels 12.

With reference to FIGS. 20 and 21, the driving device 130 comprises a plurality of first actuators 142 arranged for moving the tubular elements 46 and a plurality of second actuators 132 arranged for moving the elongated elements 47.

A number of first actuators 142 is provided corresponding to the number of further carousels 12 rotatably supported by the main carousel 11, a corresponding first actuator 142 being associated with each further carousel 11.

Similarly, a number of second actuators 143 is provided corresponding to the number of further carousels 12 rotatably supported by the main carousel 11, a corresponding second actuator 143 being associated with each further carousel 11.

The first actuators 142 and the second actuators 132 are fixed to the main carousel 11 and rotate together with the main carousel 11 around the rotation axis B.

Each first actuator 142 comprises a sleeve 144 fixed to the main carousel 11 inside which a rod 145 is slidable that has a first end 146 arranged for controlling the slide 91 and a second end 147, opposite the first end 146, at which a wheel cooperating with a cam is provided.

Similarly, each second actuator 143 comprises a further sleeve 148 fixed to the main carousel 11 inside which a further rod 149 is slidable that has a further first end 150 arranged for controlling the further slide 94 and a further second end 151, opposite the further first end 150, at which a further wheel is provided cooperating with a further cam 152 shown in FIG. 22.

The cam and the further cam 152 are arranged in a fixed position in relation to the main carousel 11.

The aforementioned wheel and the aforementioned further wheel cooperating with the cam and with the further cam 152 control the shift of the thermal-conditioning devices 13 between the open configuration H and the configuration K.

With reference to FIG. 22, the thermal-conditioning carousel 9 is shown in a schematic manner.

For ease of reference, FIG. 22 shows a pair of further carousels 12 rotatably supported by the main carousel 11, both the further carousels 12 being provided with a plurality of cooling devices 13, only one of which has been shown.

The thermal-conditioning carousel 9 comprises a conveying arrangement 62 arranged for supplying a thermal-conditioning fluid to the further carousels 12.

The conveying arrangement 62 comprises a first conveying device 63 arranged for supplying the flow of fluid to the tubular elements 46 of the cooling devices 13 and a second conveying device 64 arranged for supplying the further flow of fluid to the elongated elements 47 of the cooling devices.

The first conveying device 63 comprises a fan 65 that supplies a conduit 66 that leads into a heat exchanger 67, inside which the fluid is cooled.

Downstream of the heat exchanger 67 a hollow casing is provided 68, fixed to a supporting frame of the thermal-conditioning carousel 9 in such a way as to be maintained in a stationary condition during rotation of the main carousel 11.

As shown in FIG. 23, a first rotating manifold 69 is associated through first seal element 117 with the hollow casing 68.

The first rotating manifold 69 is rotatable, coupled with the main carousel 11, in relation to the hollow casing 68 and supplies the cooling devices 13 with which each further carousel 12 is provided.

The first rotating manifold 69 comprises a plurality of openings 118, each opening 118 being associated with a respective further carousel 12.

Each further carousel 12 comprises a second rotating manifold 119 that can rotated, coupled with the further carousel 12, in relation to the first rotating manifold 69, a second seal 120 being interposed between the second rotating manifold 119 and the first rotating manifold 69.

The second rotating manifold 119 comprises an open end 121, connecting through the opening 118, with the first rotating manifold 69.

The second rotating manifold 119, is delimited, in a zone thereof opposite the open end 121, by the plate 109 of the further carousel 12.

In operation, the fan 65 conveys, via the conduit 66, the flow of fluid to the heat exchanger 67.

The flow of fluid, after being cooled in the heat exchanger 67, passes through the hollow casing 68 and reaches the first rotating manifold 69.

Subsequently, after passing through the openings 118, the flow of fluid reaches the second rotating manifolds 119 associated with the further carousels 12.

Still subsequently, the pipe 97, connected with the second rotating manifolds 119 via the hole 111, supplies the flow of fluid to the tubular elements 46.

The second conveying device 63 comprises a further fan 70 that supplies a further conduit 71 that leads into a further heat exchanger 72, inside which the fluid is cooled.

Downstream of the further heat exchanger 72 a further hollow casing 73 is provided that is fixed to a supporting frame of the thermal-conditioning carousel 9 in such a way as to be maintained in a stationary condition during rotation of the main carousel 11.

As shown in FIG. 24, a further first rotating manifold 74 is associated with the further hollow casing 73 through further first seal elements 122.

The further first rotating manifold 74 is rotatable, coupled with the main carousel 11, in relation to the further hollow casing 73 and supplies the cooling devices 13 with which each further carousel 12 is provided.

The further hollow casing 73 comprises a plurality of further openings 123, each further opening 123 being associated with a respective further carousel 12.

Each further carousel 12 comprises a further second rotating manifold 124 that can rotate, coupled with the further carousel 12, in relation to the further first rotating manifold 74, between the further second rotating manifold 124 and the further first rotating manifold 74 a further second seal 125 being interposed.

The further second rotating manifold 124 comprises a further open end 126 connecting through the further opening 123 with the further first rotating manifold 74.

The further second rotating manifold 124 is delimited, in a zone thereof opposite the further open end 126, by the further plate 110 of the further carousel 12.

In operation, the further flow of fluid is conveyed to the elongated elements 47 in a manner that is similar to what has been disclosed above, by which the flow of fluid is conveyed to the tubular elements 46.

The first rotating manifold 69 and the further first rotating manifold 74, by cooperating respectively with the second rotating manifolds 119 and the further second rotating manifolds 124, enable each of the further carousels 12 to be supplied effectively.

Furthermore, as first conveying device 63 and second conveying device 64 that are distinct from each other are provided, it is possible to cool, through the tubular elements 46 and the elongated elements 47 of the cooling devices 13, an inside part and an outside part of the preforms with a flow of fluid and a further flow of fluid having different temperatures from one another.

In particular, it is possible to cool the internal surface 61 of the preforms 8, which normally has a greater temperature than the external surface 56 of the preforms 8, with a colder flow of fluid than a further flow of fluid that interacts with the external surface 56.

This can be obtained with great simplicity by suitably adjusting the operation of the heat exchanger 67 and of the further heat exchanger 72.

In an embodiment that is not shown, the thermal-conditioning carousel 9 is provided with a sucking arrangement, arranged for extracting the coolant fluids that have reached the external environment after cooling the preforms.

The sucking arrangement comprises a first sucking arrangement arranged next to the rotation axis B to suck a part of the coolant fluids that, after exiting the preforms 8, is directed to an internal zone of the main carousel 11, this zone being substantially comprised between a central supporting element 127 of the main carousel 11 and the further carousels 12.

The sucking arrangement furthermore comprises a second sucking arrangement arranged on the periphery of the main carousel 11 for extracting a further part of the coolant fluids that, after exiting the preforms 8, is directed to the outside of the main carousel 11.

The second sucking arrangement comprises sucking devices positioned along the trajectory along which the further carousels 12 travel and arranged at portions of this trajectory in which the further carousels 12 do not interact with further devices, such as the transferring carousel 10, 1244113 for the delivery of the preforms 8 to the cooling devices 13, and the removing carousel 33, for removing the preforms 8 from the cooling devices 13.

In another embodiment that is not shown, the first conveying device 63 and the second conveying device 64 can suck—rather than blow—a flow of fluid and a further flow of fluid.

In a further embodiment that is not shown, the first conveying device 63 can suck a flow of fluid and the second conveying device 64 can blow a further flow of fluid, or vice versa.

With reference to FIGS. 25 to 28 a thermal-conditioning carousel 109 is shown that is made according to a version.

The thermal-conditioning carousel 109 comprises a rotating disc 77 arranged inside a thermal-conditioning environment 78.

The disc 77 is provided with a plurality of channels 79 positioned radially in relation to the disc 77 and arranged for each receiving a row of preforms 8.

The disc 77 can be supplied with the preforms 8 by means of a transferring carousel that is not shown that introduces in succession a plurality of preforms 8 into adjacent channels 79, during rotation of the disc 77.

The thermal-conditioning environment 78 is delimited above by a wall 80 through which a plurality of dispensing nozzles 81 protrudes inside the conditioning environment 78 to convey a flow of fluid arranged for cooling an inside part delle preforms 8.

The wall 80 is maintained in a fixed position during rotation of the disc 77.

With the wall 80 a baffle 82 is associated that protrudes inside the thermal-conditioning environment 78 to interact with a projection with which the preforms 8 are provided, this projection being arranged for cooperating with a tamperproof ring of caps intended to seal containers obtained by moulding the preforms 8.

The baffle 82 extends along a path defined by a spiral portion.

During rotation of the disc 77, the preforms 8 received inside the channels 79, by interacting with the baffle 82, are made to shift, as shown by the arrow F, from a peripheral zone 84 of the disc 77 to a central zone 85 of the disc 77.

The dispensing nozzles 81 are arranged along the spiral trajectory along which the preforms 8 travel, in such a way that when the latter pass below the dispensing nozzles 81, the flow of fluid penetrates, at least partially into the preforms 8 cooling the internal part thereof.

A guiding element 86, provided at the central zone 85 of the disc 77, extracts the preforms from the channels 79 one at a time to direct the preforms to a chute 87 that evacuates them from the thermal-conditioning carousel 109.

The thermal-conditioning carousel 109 furthermore comprises supplying conduits 88 that introduce inside the thermal-conditioning environment 78 a further flow of fluid arranged for interacting with an external part of the preforms 8.

The supplying conduits 88 lead into the peripheral zone 84 of the disc 77 and direct the fluid substantially radially in relation to the disc 77.

The further flow of fluid, thus interacts first of all with the hotter preforms which are near to the peripheral zone 85 of the disc 77, maximising the cooling action.

Similarly to what is disclosed in the FIGS. 22 to 24, the thermal-conditioning carousel 109 comprises a first conveying device 63 arranged for supplying the dispensing nozzles 81 and a second conveying device 64 arranged for supplying the supplying conduits 88.

The first conveying device 63 comprises a fan that is not shown and a heat exchanger 67 inside which the fluid is cooled.

The second conveying device 64 comprises a further fan that is not shown and a further heat exchanger 72 inside which the fluid is cooled.

The wall 80 is provided with a plurality of holes—that are not shown—through which the fluid that has interacted with the preforms 8 is removed from the conditioning environment 78 through pipes 90, to be sent again to the first conveying device 63 and/or to the second conveying device 64.

1-136. (canceled)

137. Apparatus, comprising an extruding device arranged for supplying doses of pasty plastics, a moulding carousel provided with a mould device arranged for compression-moulding said doses to obtain objects and a thermal-conditioning device arranged for thermally conditioning said objects, wherein said thermal-conditioning device comprises a thermal-conditioning carousel distinct from said moulding carousel.

138. Apparatus according to claim 137, wherein said objects comprise container preforms.

139. Apparatus according to claim 137, wherein said thermal-conditioning carousel comprises a carousel arrangement and a conveying unit arrangement supported by said carousel arrangement and movable in relation to said carousel arrangement, a thermal-conditioning arrangement being associated with said conveying unit arrangement.

140. Apparatus according to claim 139, wherein said thermal-conditioning arrangement comprises a cooling device.

141. Apparatus according to claim 139, and further comprising a driving device arranged for rotating said carousel arrangement continuously around respective rotation axis.

142. Apparatus according to claim 139, and further comprising a driving device arranged for angularly indexing said carousel arrangement around respective rotation axis.

143. Apparatus according to claim 139, wherein said conveying unit arrangement comprises a further carousel arrangement.

144. Apparatus according to claim 143, wherein said further carousel arrangement comprises a plurality of carousels.

145. Apparatus according to claim 144, wherein said carousels are arranged circumferentially on said carousel arrangement.

146. Apparatus according to claim 144, wherein said carousels are arranged in a peripheral zone of said carousel arrangement.

147. Apparatus according to claim 144, wherein said carousels are positioned on said carousel arrangement at substantially constant angular intervals.

148. Apparatus according to claim 144, and further comprising a further driving device arranged for rotating continuously said carousels around respective rotation axes.

149. Apparatus according to claim 144, and further comprising a further driving device arranged for angularly indexing said carousels around respective rotation axes.

150. Apparatus according to claim 144, wherein said carousels are arranged substantially parallel to said carousel arrangement.

151. Apparatus according to claim 144, wherein said carousels are arranged transversally in relation to said carousel arrangement.

152. Apparatus according to claim 151, wherein said carousels are arranged substantially radially in relation to said carousel arrangement.

153. Apparatus according to claim 144, wherein each of said carousels comprises a plurality of thermal-conditioning devices of said thermal-conditioning arrangement.

154. Apparatus according to claim 153, wherein said thermal-conditioning devices are arranged circumferentially on each of said carousels.

155. Apparatus according to claim 153, wherein said thermal-conditioning devices are arranged in a peripheral zone of each of said carousels.

156. Apparatus according to claim 153, wherein said thermal-conditioning devices are positioned on said carousels at substantially constant angular intervals.

157. Apparatus according to claim 139, wherein said conveying unit arrangement comprises a loop conveying unit arrangement.

158. Apparatus according to claim 157, wherein said loop conveying unit arrangement comprises a plurality of loop conveying units.

159. Apparatus according to claim 158, wherein said loop conveying units comprise loop flexible elements that are movable in relation to said carousel arrangement and arranged for receiving said objects.

160. Apparatus according to claim 158, wherein said loop conveying units are arranged circumferentially on said carousel arrangement.

161. Apparatus according to claim 158, wherein said loop conveying units are positioned on said carousel arrangement at substantially constant angular intervals.

162. Apparatus according to claim 158, and further comprising a still further driving device arranged for driving continuously said loop conveying units.

163. Apparatus according to claim 158, and further comprising a still further driving device arranged for indexing said loop conveying units.

164. Apparatus according to claim 159, wherein said loop flexible elements extend between a peripheral region of said carousel arrangement and a central region of said carousel arrangement.

165. Apparatus according to claim 164, wherein said loop flexible elements extend substantially parallel to said carousel arrangement.

166. Apparatus according to claim 159, wherein said loop flexible elements comprise a portion nearer to said carousel arrangement and a portion farther from said carousel arrangement.

167. Apparatus according to claim 166, wherein said loop flexible elements extend transversally in relation to said carousel arrangement.

168. Apparatus according to claim 167, wherein said loop flexible elements (102) extend substantially perpendicularly in relation to said carousel arrangement.

169. Apparatus according to claim 158, wherein each of said loop conveying units comprises a plurality of thermal-conditioning devices of said thermal-conditioning arrangement.

170. Apparatus according to claim 169, wherein said thermal-conditioning devices are positioned on said loop conveying units at substantially constant intervals.

171. Apparatus according to claim 139, wherein said thermal-conditioning arrangement comprises a cavity arranged for receiving an object of said objects, in such a way that between said cavity and an external surface of said object there is defined a chamber, a supplying element arranged for directing a flow of conditioning fluid to an end of said object, an elongated element arranged for being received in said object through an opening of said object in such a way that between said elongated element and an internal surface of said object there is defined a further chamber, said elongated element being arranged for directing a further flow of conditioning fluid to said end.

172. Apparatus according to claim 171, wherein said cavity and said elongated element are movable towards and away from one another.

173. Apparatus according to claim 137, wherein said thermal-conditioning carousel comprises a conditioning chamber inside which there is defined a guiding arrangement along which said objects are advanced in such a way as to define rows, said guiding arrangement being obtained in a carousel arrangement provided inside said conditioning chamber.

174. Apparatus according to claim 173, wherein said guiding arrangement extends between a peripheral zone of said carousel arrangement and a central zone of said carousel arrangement.

175. Apparatus according to claim 174, wherein said guiding arrangement is arranged substantially radially in relation to said carousel arrangement.

176. Apparatus according to claim 173, and further comprising a moving arrangement arranged for moving said objects along said guiding arrangement.

177. Apparatus according to claim 176, wherein said moving arrangement comprises a deviating element arranged in a fixed position in relation to said carousel arrangement to interact with said objects.

178. Apparatus according to claim 177, wherein said guiding arrangement extends between a peripheral zone of said carousel arrangement and a central zone of said carousel arrangement and said deviating element comprises a baffle extending along a path converging from said peripheral zone to said central zone.

179. Apparatus according to claim 178, wherein said path comprises a spiral portion.

180. Apparatus according to claim 178, wherein said baffle protrudes inside said conditioning chamber from a wall that delimits said conditioning chamber.

181. Apparatus according to claim 180, wherein said wall is arranged substantially parallel to said carousel arrangement.

182. Apparatus according to claim 173, and further comprising a dispensing nozzle arrangement arranged for directing a flow of fluid to said objects

183. Apparatus according to claim 182, and further comprising a moving arrangement arranged for moving said objects along said guiding arrangement, said moving arrangement comprising a deviating element arranged in a fixed position in relation to said carousel arrangement to interact with said objects, said guiding arrangement extending between a peripheral zone of said carousel arrangement and a central zone of said carousel arrangement and said deviating element comprising a baffle extending along a path converging from said peripheral zone to said central zone, wherein said dispensing nozzle arrangement comprises a plurality of nozzles arranged substantially along said path.

184. Apparatus according to claim 182, and further comprising a moving arrangement arranged for moving said objects along said guiding arrangement, said moving arrangement comprising a deviating element arranged in a fixed position in relation to said carousel arrangement to interact with said objects, said guiding arrangement extending between a peripheral zone of said carousel arrangement and a central zone of said carousel arrangement and said deviating element comprising a baffle extending along a path converging from said peripheral zone to said central zone, said baffle protruding inside said conditioning chamber from a wall that delimits said conditioning chamber, wherein said dispensing nozzle arrangement is associated with said wall.

185. Apparatus according to claim 184, wherein said dispensing nozzle arrangement protrudes inside said conditioning chamber from said wall in such a way as to direct said flow of fluid to an inside part of said objects.

186. Apparatus according to claim 173, and further comprising a conveying device arranged for conveying a further flow of fluid to said conditioning chamber.

187. Apparatus according to claim 186, wherein said guiding arrangement extends between a peripheral zone of said carousel arrangement and a central zone of said carousel arrangement, wherein said conveying device leads into said conditioning chamber at said peripheral zone.

188. Apparatus according to claim 173, and further comprising a removing device arranged for removing a conditioning fluid from said conditioning chamber after said conditioning fluid has interacted with said objects.

189. Apparatus according to claim 188, and further comprising a moving arrangement arranged for moving said objects along said guiding arrangement, said moving arrangement comprising a deviating element arranged in a fixed position in relation to said carousel arrangement to interact with said objects, said guiding arrangement extending between a peripheral zone of said carousel arrangement and a central zone of said carousel arrangement and said deviating element comprising a baffle extending along a path converging from said peripheral zone to said central zone, said baffle protruding inside said conditioning chamber from a wall that delimits said conditioning chamber, wherein said removing device comprises a sucking arrangement associated with a removing opening arrangement obtained in said wall.

190. Apparatus according to claim 189, wherein said removing opening arrangement comprises a plurality of holes.

191. Apparatus according to claim 137, and further comprising an extracting carousel arranged for removing said objects from said thermal-conditioning carousel.

192. Apparatus according to claim 191, wherein an inspecting device arranged for examining said objects is associated with said extracting carousel.

193. Apparatus according to claim 192, wherein said inspecting device comprises a television-camera arranged for acquiring images of said objects.

194. Apparatus according to claim 193, wherein said inspecting device further comprises a lighting device arranged for lighting said objects and cooperating with said television-camera.
